(19) United States
(12) Patent Application Publication
(10) Pub. No.: US 2026/0021901 A1
(43) Pub. Date: Jan. 22, 2026

(54) AIR DATA PROBE INTEGRATED WITH AN INVERTED SINGLE HELIX HEATER CABLE AND METHOD THEREOF

(71) Applicant: Misochain Technologies Private Limited, Bangalore (IN)

(72) Inventors: Murali Payangapadan Krishnan, Bangalore (IN); Kandula Venkata Rama Sateesh, Bangalore (IN)

(21) Appl. No.: 19/276,108

(22) Filed: Jul. 22, 2025

(30) Foreign Application Priority Data
Jul. 22, 2024 (IN) 202441055703

(51) Int. Cl. B64D 43/02; B64D 15/12; H05B 1/02; H05B 3/56

(52) U.S. Cl. CPC B64D 43/02; B64D 15/12; H05B 1/0236; H05B 3/56; H05B 2203/002; H05B 2214/02

(57) ABSTRACT

The present invention discloses an air data probe integrated with an inverted single helix heater cable for controlling one or more icing parameters. The air data probe comprises a hollow structure and one or more grooves. The hollow structure is designed such that it is exposed to fluid during flight, allowing for interaction with one or more icing parameters. The one or more grooves provide a path for an electrical heater cable. The electrical heater cable, featuring an underside bend for efficient heat distribution is integrated into the one or more grooves. The inverted single helix heater cable significantly elevates performance during icing conditions by maintaining optimal temperatures at critical areas prone to icing.

This Application claims priority from a Provisional patent application filed in India having patent application Ser. No. 20/244,1055703, filed on Jul. 22, 2024 and titled “AIR DATA PROBE INTEGRATED WITH AN INVERTED SINGLE HELIX HEATER CABLE AND METHOD THEREOF”.

### FIELD OF INVENTION

Embodiments of the present invention relate to air data probes and more particularly relate to the air data probe integrated with an inverted single helix heater cable for controlling one or more icing parameters.

### BACKGROUND

Icing poses a significant challenge for various aircraft, including fixed-wing aircraft, helicopters, Unmanned Aerial Vehicles (UAVs), fighter jets, and Urban Air Mobility (UAM) systems. When flying through clouds or areas of high humidity at altitudes where temperatures are below freezing, water droplets in air freeze upon contact with surfaces of the aircraft. This results in the formation of an ice on critical components such as wings, propellers, air data probes, sensors, and airspeed indicators, affecting aerodynamic performance, visibility, and instrument readings. The icing leads to reduced lift, increased drag, loss of control, incorrect speed measurement, and potentially catastrophic accidents.

Traditional methods to prevent the icing on the critical components of the aircraft comprise electric heating elements, pneumatic boots, hot bleed air, and chemical treatments. The electric heating elements are installed on critical surfaces such as the wings, engine inlets, and the sensors. The electric heating elements work by generating a heat to prevent the ice formation (anti-icing) and to melt the existing ice (de-icing). One disadvantage of the electric heating elements is their energy consumption, which drains power from an electrical system of the aircraft, especially during prolonged periods of operation. Additionally, the electric heating elements are not effective in all icing conditions, particularly in areas with heavy precipitation and rapidly changing temperatures.

The pneumatic boots are inflatable rubber membranes installed on leading edges of the wings and tail surfaces. When activated, the pneumatic boots inflate and break the bond between the ice and the surface of the aircraft, allowing the ice to be shed. However, the pneumatic boots have limitations, including the risk of damage from repeated inflations and deflations, potential delays in the ice removal, and the need for periodic maintenance to ensure proper function.

The chemical treatments involve the application of anti-icing fluids or de-icing solutions to the surfaces of the aircraft before or during flight. The anti-icing fluids create a protective layer that prevents the ice from forming or facilitates its removal. However, the chemical treatments are expensive, require specialised equipment for storage and application, and have environmental implications due to the use of potentially harmful chemicals. Additionally, the effectiveness of the chemical treatments is limited in certain conditions, such as heavy precipitation or prolonged exposure to freezing temperatures. Furthermore, the chemical treatments are only used for de-icing conditions as the aircraft on a ground and cannot be used in flight conditions.

In the existing technology, measuring equipment is disclosed. The measuring equipment comprises a heating device and is configured for placement outside and at a skin level of the aircraft suitable for travelling in harsh climatic conditions, particularly icy environments. The measuring equipment comprises a body formed of a shaft carrying a tube closed at one of its end, with a heating device intended for housing within the tube. The heating device includes at least a one wound heating wire within the body of the tube. The winding of the heating wire is characterised by a round-trip bridged winding. This winding configuration is defined by the presence of a bridge, which corresponds to a portion overlapping the heating wire along the axis of the tube. A predetermined number of turns at an end of the winding, located near an open end of the tube, feature the overlapped turns that are regularly spaced according to a predetermined pitch associated with an overlapping area. Nevertheless, the heating device fails to optimise heat distribution along the surface of the critical components of the aircraft.

Similarly in another existing technology, the air data probe with double helical coil heater cable is disclosed. The air data probe comprises an elongated body structure with an outer surface and an inner surface, housing an interior channel, extending from a proximal to a distal end. A probe tip at the distal end is connected seamlessly to the body structure, featuring an opening allowing outside air into the interior channel. An electrical heater cable is linked to both the body structure and the probe tip, typically in a compact double-layer helix configuration. Yet, the electric heater struggles to distribute the heat effectively, leading to the problematic icing, particularly at the highly vulnerable probe tip. This inadequate heating not only fails to maintain optimal temperatures at critical areas but also compromises the overall air data probe performance.

There are various technical problems with the traditional methods in the prior art. In the existing technology, existing traditional heating methods employed in the air data probes struggle to distribute the heat with different power densities along the probe, causing the ice accumulation problems, especially at the susceptible probe tip. This inadequate heating not only hinders the preservation of the optimal temperatures but also undermines the overall functionality of the air data probe, failing to meet a stringent precision criterion mandated by industry ice testing standards.

Therefore, there is a need for a system to address the aforementioned issues by providing a solution that effectively controls one or more icing parameters in the air data probes, ensuring reliable and accurate measurements during the operation of the aircraft.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In order to overcome the above deficiencies of the prior art, the present disclosure is to solve the technical problem by providing an air data probe integrated with an inverted single helix heater cable for controlling one or more icing parameters.

In accordance with an embodiment of the present invention, the air data probe integrated with the inverted single helix heater cable for controlling the one or more icing parameters is disclosed. The air data probe comprises a hollow structure and one or more grooves.

In an embodiment, the hollow structure comprises a first end, a second end, and a first surface. The hollow structure is configured to be in contact with fluid associated with the one or more icing parameters during flight at the first end. The one or more icing parameters comprises at least one of an: ice accumulation, temperature drops, anti-icing conditions, de-icing conditions. A diameter of the hollow structure at the first end is diminished compared to the diameter of the hollow structure at the second end.

In an embodiment, the one or more grooves form on the first surface of the hollow structure with a varying pitch from the first end to the second end. The one or more grooves is configured to provide a path for an electrical heater cable. The one or more grooves is formed on the first surface is configured with a spiral pattern for providing the path for the inverted single helix heater cable.

In an embodiment, the electrical heater cable is fabricated with an underside bend at a third end of the electrical heater cable to form the inverted single helix heater cable for providing an elevated heat at the first end of the hollow structure. The underside bend is configured with a 90° angle with an optimal bending radius for averting breakage and internal cracks at elevated temperatures. The electrical heater cable is selected from a group that comprises nichrome, constantan, copper-nickel alloys, tungsten, and stainless steel.

In an embodiment, the electrical heater cable is operatively connected to a heat source. The heat source is configured to provide the heat to the electrical heater cable for elevating a heat transfer to control the one or more icing parameters.

In accordance with an embodiment of the present invention, a method for controlling the one or more icing parameters in the air data probe integrated with the inverted single helix heater cable is disclosed. In the first step, the method includes contacting, by the hollow structure, the fluid associated with the one or more icing parameters during the flight at the first end. In the next step, the method includes providing, by the one or more grooves, the path for the electrical heater cable, on the first surface of the hollow structure with the varying pitch from the first end to the second end.

In the next step, the method includes providing, by the electrical heater cable, the elevated heat at the first end of the hollow structure to control the one or more icing parameters in the air data probe integrated with the inverted single helix heater cable. The inverted single helix heater cable is formed with the underside bend at the third end of the electrical heater cable.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail with the accompanying figures in which:

FIG. 1A illustrates an exemplary isometric view of an air data probe, in accordance with an embodiment of the present invention;

FIGS. 1B-1E illustrate exemplary isometric views of an electrical heater cable, in accordance with an embodiment of the present invention; and

FIG. 2 illustrates an exemplary flow chart depicting a method for controlling one or more icing parameters in the air data probe integrated with an inverted single helix heater cable, in accordance with an embodiment of the present invention.

Further, those skilled in the art will appreciate that elements in the figures are illustrated for simplicity and may not have necessarily been drawn to scale. Furthermore, in terms of the method steps, chemical compounds, equipments and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE PRESENT INVENTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more components, compounds, and ingredients preceded by “comprises . . . a” does not, without more constraints, preclude the existence of other components or compounds or ingredients or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

The term “one or more freeze parameters” refers to factors such as Liquid Water Content (LWC), Iced Water Content (IWC), and other related metrics. These parameters encompass the presence of supercooled water droplets below 0 degrees Celsius, ice crystals, and combinations of both, known as Mixed Phase conditions.

Embodiments of the present invention relate to an air data probe integrated with an inverted single helix heater cable for controlling one or more icing parameters.

As used herein the term “air data probe 100” also known as the pitot-static probe, is an essential component of aircraft instrumentation systems. The air data probe 100 is positioned on an exterior of an aircraft. The air data probe 100 provides air parameters including airspeed, altitude, and angle of attack during a flight.

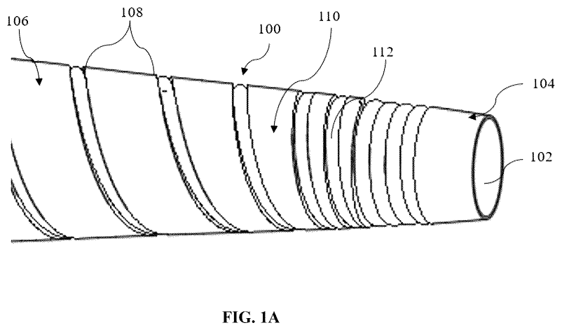

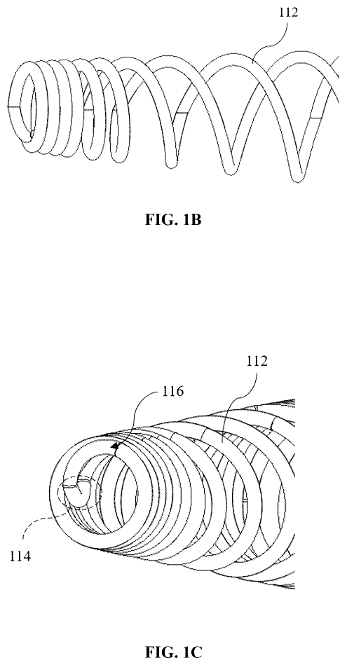

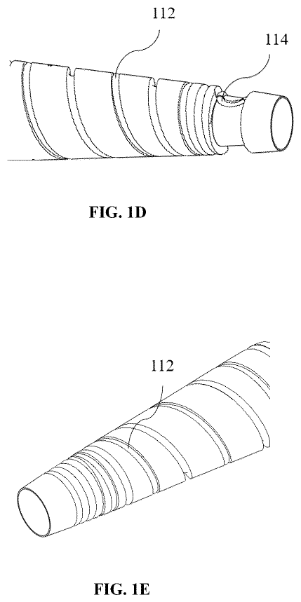

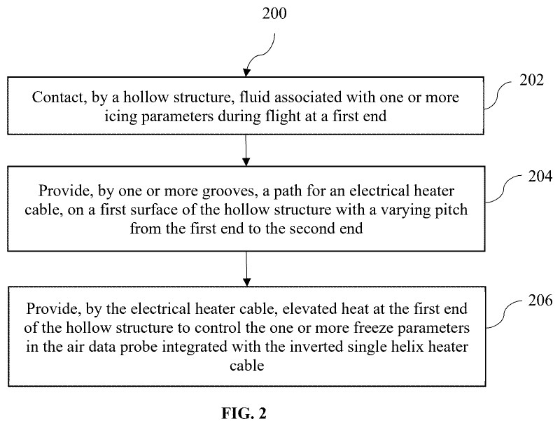

FIG. 1A illustrates an exemplary isometric view of the air data probe 100, in accordance with an embodiment of the present invention; and

FIGS. 1B-1E illustrate exemplary isometric views of an electrical heater cable 112, in accordance with an embodiment of the present invention.

According to an exemplary embodiment of the disclosure, the air data probe 100 integrated with the inverted single helix heater cable for controlling the one or more icing parameters is disclosed. The air data probe 100 comprises a hollow structure 102 and one or more grooves 108.

In an exemplary embodiment, the hollow structure 102 of the air data probe 100 comprises a first end 104, a second end 106, and a first surface 110. The hollow structure 102 is meticulously designed such that the first end 104 is exposed to fluid, specifically air, during flight, allowing for interaction with the one or more icing parameters. The one or more icing parameters may comprise, but not limited to, at least one of an: ice accumulation, temperature drop, anti-icing conditions, de-icing condition, and the like.

Moreover, a distinctive feature of the hollow structure 102 is an intentional variation in a diameter from the first end 104 of the hollow structure 102 to the second end 106 of the hollow structure 102. At the first end 104 of the hollow structure 102, the diameter is diminished compared to that at the second end 106 of the hollow structure 102 to form a tapering design. This tapering design serves multiple purposes. Firstly, this tapering design enhances aerodynamic properties of the air data probe 100, reducing drag and minimising disturbances to the fluid flow. Secondly, the diameter difference influences fluid dynamics within the air data probe 100 to control the one or more icing parameters. This strategic design choice underscores the meticulous engineering behind the air data probe 100, ensuring the effectiveness in challenging atmospheric conditions encountered during the flight operations.

In an exemplary embodiment, the one or more grooves 108 is formed along the first surface 110 of the hollow structure 102, extending longitudinally from the first end 104 to the second end 106. The one or more grooves 108 is strategically crafted with a varying pitch, meaning a distance between successive turns of the one or more grooves 108 changes gradually from the first end 104 to the second end 106 of the hollow structure 102. This variation in the pitch is purposefully engineered to provide an elevated heat at the first end 104 where the one or more icing parameters are extreme. In an exemplary embodiment, the varying pitch ranges between 1.5 millimetres (mm) to 20 millimetres (mm) from the first end 104 to the second end 106.

A primary function of the one or more grooves 108 is to provide a dedicated path for the electrical heater cable 112. By incorporating the one or more grooves 108 along the first surface 110 of the hollow structure 102, the inverted single helix heater cable is securely and efficiently housed on the hollow structure 102 of the air data probe 100. The one or more grooves 108 is configured with a spiral pattern tailored to accommodate the path of the inverted single helix heater cable, thereby ensuring the inverted single helix heater cable remains securely in place without obstructing the fluid flow and interfering with other components of the air data probe 100. This meticulous arrangement not only facilitates the effective heating of the air data probe 100 to prevent icing but also maintains an aerodynamic efficiency and an overall performance of the air data probe 100 during the flight operation.

In an exemplary embodiment, the electrical heater cable 112 is a single cable fabricated with an underside bend 114 at a third end 116 of the electrical heater cable 112 to form the spiral pattern. The underside bend 114 is precisely crafted to form the inverted single helix heater cable, responsible for providing the elevated heat at the first end 104 of the hollow structure 102. The inverted single helix heater cable ensures efficient heat distribution, effectively preventing the icing issues at the first end 104. The electrical heater cable 112 is selected from a group comprises, but not limited to, one of a: nichrome, constantan, copper-nickel alloys, tungsten, stainless steel, and the like.

In an alternative exemplary embodiment, to enhance a heat transfer and protect the electrical heater cable 112, a protective composite material is applied around the electrical heater cable 112. The protective composite material is designed to withstand the high temperatures and harsh environmental conditions. The protective composite material is composed of materials similar to those employed in constructing the hollow structure 102. The hollow structure 102 is constructed from the materials that may comprise, but not limited to, at least one of a: aluminium alloy, stainless steel, Nickel (Ni), Copper (Cu), and the like.

In an alternative exemplary embodiment, the underside bend 114 of the electrical heater cable 112 is engineered with exacting precision, forming a sharp 90° angle. This angle is strategically chosen to optimise the performance of the electrical heater cable 112 while minimising the risk of breakage and internal cracks at the elevated temperatures. In an alternative embodiment, the angle of the underside bend 114 may change according to the requirements, allowing for flexibility in accommodating various design considerations. Additionally, the underside bend 114 is configured with an optimal bending radius, carefully determined to avert any potential damage and stress on the electrical heater cable 112 during installation and operation. This meticulous attention to detail in the design of the electrical heater cable 112 underscores the commitment to quality and performance excellence in construction of the air data probe 100.

Simultaneously, the electrical heater cable 112, now integrated into the air data probe 100 is operatively connected to a heat source (not shown). The heat source is configured to provide the necessary heat to the electrical heater cable 112 during the flight, thereby elevating the heat transfer and heat distribution. The heat distributes uniformly along the surface of the air data probe 100, specifically targeting critical areas prone to the icing including tip regions and dam regions. The heat source may comprise, but not limited to, at least one of a: electrical resistive heater, heating coil, infrared heater, ceramic heater, hot air blower, and the like.

In an alternative exemplary embodiment, the electrical heater cable 112, which may vary in dimensions from 1 millimetre (mm) to 2 millimetres (mm) in diameter, is designed to accommodate different resistances based on the input power supply, whether it is Volts Alternating Current (VAC) or Volts Direct Current (VDC) voltage. The electrical heater cable 112 includes a progressive bend, rather than the sharp 90° angle bend, to smoothly redirect the electrical heater cable 112 to the opposite direction, ensuring efficient and reliable heating performance while minimizing the risk of the electrical heater cable 112 damage.

The heat source is configured to adjust the temperature output to provide the heat within the desired range, such as maintaining the temperature above 10° C. within the hollow structure 102.

Henceforth, by increasing the heat transfer of the electrical heater cable 112, the electrical heater cable 112 becomes more effective in controlling the one or more icing parameters encountered during the operation of the air data probe 100.

FIG. 2 illustrates an exemplary flow chart depicting a method 200 for controlling one or more icing parameters in the air data probe integrated with the inverted single helix heater cable, in accordance with an embodiment of the present invention.

According to an exemplary embodiment of the disclosure, the method 200 for controlling the one or more icing parameters in the air data probe integrated with the inverted single helix heater cable is disclosed. At step 202, the method 200 includes the hollow structure is designed such that the first end is exposed to the fluid during the flight, allowing for interaction with the one or more icing parameters.

At step 204, the method 200 includes providing the path for the electrical heater cable via the one or more grooves on the first surface of the hollow structure. The one or more grooves feature the varying pitch along the first end of the hollow structure to the second end of the hollow structure, optimising the positioning of the electrical heater cable for the effective heat distribution.

At step 206, the method 200 includes the electrical heater cable providing the elevated heat at the first end of the hollow structure. This focused application of the heat is crucial for preventing the ice formation and ensuring optimal functionality of the air data probe, particularly in the critical areas where the icing is most likely to occur. Notably, the inverted single helix heater cable is configured with the underside bend at the third end of the electrical heater cable. The underside bend optimises a structure of the inverted single helix heater cable, ensuring the efficient heat distribution along the surface of the air data probe.

Numerous advantages of the present disclosure may be apparent from the discussion above. In accordance with the present disclosure, the air data probe integrated with the inverted single helix heater cable for controlling the one or more icing parameters is disclosed. The inverted single helix heater cable winding design optimises heat concentration specifically at the vulnerable tip of the air data probe and effectively prevents the icing in critical areas. By strategically utilising the optimal bending radius of the electrical heater cable, the electrical heater cable ensures more uniform and efficient heat distribution along the surface of the air data probe. This minimises hot spots and promotes consistent heating throughout, mitigating the potential icing issues.

The design significantly elevates performance during the icing conditions by maintaining the optimal temperatures at the critical areas prone to the icing. This ensures that the air data probe continues to function accurately even in challenging environmental conditions. The design exceeds icing testing standards by providing more reliable and effective anti-icing and de-icing capabilities. The design meets regulatory demands for enhanced accuracy and performance in the air data probe.

The electrical heater cable minimises the occurrence of icing within the air data probe, notably at the tip regions and the dam regions, preventing potential operational disruptions caused by ice accumulation.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I/we claim:

1. An air data probe integrated with an inverted single helix heater cable for controlling one or more icing parameters, comprising:
a hollow structure comprises a first end, a second end and a first surface, configured to be in contact with fluid associated with the one or more icing parameters during flight at the first end; and
one or more grooves form on the first surface of the hollow structure with a varying pitch from the first end to the second end, configured to provide a path for an electrical heater cable,
wherein the electrical heater cable is fabricated with an underside bend at a third end of the electrical heater cable to form the inverted single helix heater cable for providing an elevated heat at the first end of the hollow structure, thereby controlling the one or more icing parameters.

2. The air data probe as claimed in claim 1, wherein one or more icing parameters comprises at least one of an: ice accumulation, temperature drops, anti-icing conditions, de-icing conditions.

3. The air data probe as claimed in claim 1, wherein a diameter of the hollow structure at the first end is diminished compared to the diameter of the hollow structure at the second end.

4. The air data probe as claimed in claim 1, wherein the one or more grooves formed on the first surface configured with a spiral pattern for providing the path for the inverted single helix heater cable.

5. The air data probe as claimed in claim 1, wherein the underside bend is configured with a 90° angle with an optimal bending radius for averting breakage and internal cracks at elevated temperatures.

6. The air data probe as claimed in claim 1, wherein the electrical heater cable is operatively connected to a heat source (not shown), the heat source (not shown) is configured to provide the heat to the electrical heater cable for elevating a heat transfer to control the one or more icing parameters.

7. The air data probe as claimed in claim 1, wherein the electrical heater cable is selected from a group comprises, nichrome, constantan, copper-nickel alloys, tungsten, and stainless steel.

8. A method for controlling one or more icing parameters in an air data probe integrated with an inverted single helix heater cable, comprising:
contacting, by a hollow structure, fluid associated with the one or more icing parameters during flight at a first end;
providing, by one or more grooves, a path for an electrical heater cable, on a first surface of the hollow structure with a varying pitch from the first end to the second end; and
providing, by the electrical heater cable, elevated heat at the first end of the hollow structure to control the one or more icing parameters in the air data probe integrated with the inverted single helix heater cable.

9. The method as claimed in claim 8, wherein the inverted single helix heater cable is formed with an underside bend at a third end of the electrical heater cable.
